(19) United States
(12) Patent Application Publication
(10) Pub. No.: US 2021/0012158 A1
(43) Pub. Date: Jan. 14, 2021

(54) LEARNING APPARATUS, IDENTIFICATION APPARATUS, METHODS THEREOF, AND PROGRAM

(71) Applicant: NIPPON TELEGRAPH AND TELEPHONE CORPORATION, Chiyoda-ku (JP)

(72) Inventors: Ryo MASUMURA, Yokosuka-shi (JP); Tomohiro TANAKA, Yokosuka-shi (JP)

(73) Assignee: NIPPON TELEGRAPH AND TELEPHONE CORPORATION, Chiyoda-ku (JP)

(21) Appl. No.: 16/969,283

(22) PCT Filed: Feb. 14, 2019
(86) PCT No.: PCT/JP2019/005194

§ 371 Date: Aug. 12, 2020

(30) Foreign Application Priority Data
Feb. 16, 2018 (JP) 2018-026105

(51) Int. Cl. G06K 9/62; G06N 7/00; G06N 20/00

(52) U.S. Cl. CPC G06K 9/6256; G06N 7/005; G06N 20/00; G06K 9/6226; G06K 9/6244

(57) ABSTRACT

By using training data containing tuples of texts for M types of tasks in N types of languages and correct labels of the texts as input, an optimized parameter group that defines N inter-task shared transformation functions α(n) corresponding to the N types of languages n and M inter-language shared transformation functions β(m) corresponding to the M types of tasks in is obtained. At least one of N and M is an integer greater than or equal to 2, each α(n) outputs a latent vector, which corresponds to the contents of an input text in a certain language n but does not depend on the language n, to β(1), . . . β(M), and each β(m) uses, as input, the latent vector output from any one of α(1), . . . α(N) and outputs an output label corresponding to the latent vector for a certain task in.

### TECHNICAL FIELD

The present invention relates to text label identification techniques of performing text label identification on a particular task from a text and, in particular, relates to a text label identification technique supporting a plurality of tasks in a plurality of languages.

### BACKGROUND ART

Text label identification techniques of performing label identification on a particular task from a text are known. For example, in interactive systems including a chat bot, it is common to perform text label identification on a plurality of tasks such as utterance intention identification, utterance act identification, and topic identification from a user's input text and determine an action of the system based on the identification result. In an existing text label identification technique, a text label discriminator is provided for each task to be processed and text label identification is performed on each task. For instance, in the task of utterance act identification, a text label discriminator that identifies a label corresponding to an input text is constructed for a predetermined number of labels (for example, 30 labels) indicating utterance acts and text label identification is performed. The text label discriminator plays the role of assigning a label “question” to an input text “Do you sell juice in this store?”, for example. It is important to improve the performance of such a text label discriminator; in the above-described interactive systems, the smoothness of a dialogue depends on the performance of the text label discriminator.

It is common to construct such a text label discriminator by machine learning by preparing a large amount of training data containing tuples of texts and correct labels thereof. That is, by preparing a large amount of data on texts (word sequences), each being assigned with a label, a text label discriminator is automatically learned. Various machine learning techniques can be applied to this learning; for example, machine learning techniques such as deep learning can be used. Examples of a representative deep learning method include a recurrent neural network (RNN) and a convolutional neural network (CNN) (see Non-patent Literatures 1 and 2 and the like).

An existing text label discriminator of RNN, CNN, or the like is formulated as follows:

\hat{L}=DISCRIMINATE(w; θ),

where DISCRIMINATE( )is a function that estimates, for an input text w=(w₁, . . . w_{T}), an output label L\hat{ } corresponding to the input text w and outputs the output label L\hat{ } in accordance with a parameter θ that defines a text label discriminator. Here, wₜ represents one word, t=1, . . . , T holds, and T is the number of words contained in the input text w. A superscript “\hat{ }” of “L\hat{ }” is supposed to be placed directly above “L”, but, due to notational constraints, it is sometimes written as “L\hat{ }”. The role of DISCRIMINATE( ) can be divided into two components, one of which is a function INPUTtoHIDDEN( ) that transforms the input text w to a latent vector h and the other is a function HIDDENtoOUTPUT( ) that transforms the latent vector h to an output label L\hat{ }. The existing text label discriminator is formulated by these functions as follows.

h=INPUTtoHIDDEN (w; θ_{IN})

\hat{L}=HIDDENtoOUTPUT(h; θₒᵤₜ

Here, h is a latent vector in which information on an input text is embedded, θ={θ_{IN}, θ_{OUT}} holds, θ_{IN} is a parameter that defines the processing of INPUTtoHIDDEN( ), and θ_{OUT} is a parameter that defines the processing of HIDDENtoOUTPUT( ).

In the existing technique, by using training data dedicated to a particular task (an identification task, for example, utterance intention identification, utterance act identification, topic identification, or the like) in a particular language (for example, Japanese, Chinese, English, or the like), a text label discriminator dedicated to a particular task in a particular language is learned. That is, for learning of parameters of one text label discriminator and another text label discriminator which is different from the one text label discriminator in at least one of a language and a task, training data and another training data, which are completely different from each other, are used.

### PRIOR ART LITERATURE

### Non-Patent Literature

Non-patent Literature 1: Suman Ravuri, Andreas Stolcke, “Recurrent Neural Network and LSTM Models for Lexical Utterance Classification,” In Proc. INTERSPEECH, pp. 135-139, 2015.

Non-patent Literature 2: Yoon Kim, “Convolutional Neural Networks for Sentence Classification,” In Proc. EMNLP, pp. 1746-1751, 2014.

### SUMMARY OF THE INVENTION

### Problems to be Solved by the Invention

However, it is difficult to sufficiently prepare training data dedicated to a particular task in a particular language. This sometimes makes it impossible to sufficiently learn parameters, resulting in construction of a low-performance text label discriminator. This results from a complete difference between parameters that define one text label discriminator and parameters that define another text label discriminator which is different from the one text label discriminator in at least one of a language and a task.

The present invention has been made in view of this point and performs high-performance text label identification on a plurality of tasks in a plurality of languages.

### Means to Solve the Problems

By using training data containing tuples of texts for M types of tasks m=1, . . . , M in N types of languages n=1, . . . , N and correct labels of the texts as input, an optimized parameter group that defines N inter-task shared transformation functions α(1), a(N) corresponding to the N types of languages n=1, . . . , N and M inter-language shared transformation functions β(1), . . . , β(M) corresponding to the M types of tasks m=1, . . . , M is obtained by learning processing and output. Here, N and M are integers greater than or equal to 2. Each of the inter-task shared transformation functions α(n) uses an input text in a certain language n as input and outputs a latent vector, which corresponds to the contents of the input text but does not depend on the language n, to the M inter-language shared transformation functions β(1), . . . , β(M). Each of the inter-language shared transformation functions βuses, as input, the latent vector output from any one of the N inter-task shared transformation functions α(1), . . . , α(N) and outputs an output label corresponding to the latent vector for a certain task in.

### Effects of the Invention

This makes it possible to perform high-performance text label identification on a plurality of tasks in a plurality of languages.

### BRIEF DESCRIPTION OF THE DRAWINGS

FIG. 1 is a block diagram showing the functional configuration of an identification system of an embodiment.

FIG. 2 is a block diagram showing the functional configuration of a learning apparatus of the embodiment.

FIG. 3 is a block diagram showing the functional configuration of an identification apparatus of the embodiment.

FIG. 4 is a flow diagram for explaining identification processing of the embodiment.

### DETAILED DESCRIPTION OF THE EMBODIMENTS

Hereinafter, an embodiment of the present invention will be to described.

[Principles]

First, the principles will be described. A scheme of the embodiment allows parameters of text label discriminators, each being configured with two components: a function that transforms a word sequence to a latent vector and a function that transforms the latent vector to an output label, to be shared between different languages and different tasks. An identification apparatus, which will be described in the embodiment, is an apparatus in which text label discriminators are installed, and handles N types of languages and M types of tasks (identification tasks). It is to be noted that a “task” which is handled in the present embodiment is an “identification task” and identifies a classification (a class) corresponding to an input text and outputs a label corresponding to the classification as an output label. Events in a particular category are classified into a plurality of (a predetermined number of) “classifications”. For example, events in a category “utterance act” are classified into “classifications” such as “question”, “answer”, “gratitude”, and “apology”. Examples of a “task” are utterance intention identification which is identification of an utterance intention corresponding to an input text, utterance act identification which is identification of an utterance act corresponding to an input text, topic identification which is identification of a topic corresponding to an input text, and so forth. A “language” is a language of an input text. Examples of a “language” are Japanese, Chinese, English, and so forth. At least one of N and M is an integer greater than or equal to 2. For example, both N and M are integers greater than or equal to 2. When the identification apparatus handles three languages: Japanese, English, and Chinese, N =3 holds; when the identification apparatus handles two tasks: topic identification and utterance act identification, M=2 holds.

The identification apparatus, which will be described in the embodiment, includes N inter-task shared transformation units (inter-task shared word-sequence latent-vector transformation units) A(n) corresponding to the N types of languages n=1, . . . , N and M inter-language shared transformation units (inter-language shared latent-vector output-label transformation units) B(m) corresponding to the M types of tasks m=1, . . . , M. N inter-task shared transformation functions (inter-task shared transformation models) α(1), . . . , α(N) corresponding to the N types of languages n=1, . . . , N and M inter-language shared transformation functions (inter-language shared transformation models) β(1), . . . , β(M) corresponding to the M types of tasks m=1, . . . , M are defined by machine learning, which will be described later. Each inter-task shared transformation unit A(n) applies an inter-task shared transformation function α(n) to an input text in a certain language n and outputs a latent vector, which corresponds to the contents of the input text but does not depend on the language n, to the M inter-language shared transformation units B(1), . . . , B(M). Each inter-language shared transformation unit B(m) applies (operates) an inter-language shared transformation function β13(m) to (on) the latent vector output from any one of the N inter-task shared transformation units A(1), . . . , A(N) and outputs an output label corresponding to the latent vector for a certain task m. The inter-task shared transformation unit A(n) is a part which is jointly used by text label estimators that handle the same language n. For example, text label discriminators that handle both Japanese topic identification and Japanese utterance act identification use the same inter-task shared transformation unit A(n) using an inter-task shared transformation function α(n) defined by the same parameter. The “latent vector” is a vector (for example, a vector of fixed length) in which information on the contents of an input text is embedded. The “latent vector” corresponds to the contents of an input text but does not depend on a language of the input text. That is, irrespective of the language, the same “latent vector” corresponds to input texts whose contents are the same. The inter-language shared transformation unit B(m) is a part which is jointly used by text label discriminators that handle the same task m. That is, a text label discriminator that performs English topic identification and a text label discriminator that performs Japanese topic identification use the same inter-language shared transformation unit B(m) using an inter-language shared transformation function β(m) which is defined by the same parameter. When the N types of languages and the M types of tasks are handled, a text label discriminator has to be prepared for each tuple of a language and a task in an existing scheme. That is, N*M “functions that transform an input text to a latent vector” and N*M “functions that transform the latent vector to an output label” are needed. On the other hand, in the scheme of the present embodiment, it is possible to construct text label discriminators that handle the N types of languages and the M types of tasks using the N inter-task shared transformation functions α(1), . . . ,α(N) and the M inter-language shared transformation functions β(1), . . . , β(M). In addition, since the scheme of the present embodiment makes it possible to perform machine learning using a set of training data on all the combinations of the N types of languages and the M types of tasks (details will be described later), it is possible to construct a high-performance text label estimator even when the amount of training data of each task in each language is small. Moreover, when a sufficient amount of training data is obtained, it is possible to obtain more generalized parameters, which makes it possible to construct a high-performance text label estimator as compared to when a text label estimator is constructed for each task in each language as in the existing scheme.

<Identification Apparatus>

The identification apparatus of the present embodiment includes the N inter-task shared transformation units A(n) (where n=1, . . . , N) and the M inter-language shared transformation units B(m) (where m=1, . . . , M). The number of inter-task shared transformation units A(n) is equal to the number of languages which can be handled by text label estimators installed in the identification apparatus. For example, the identification apparatus in which text label estimators that handle three languages, Japanese, English, and Chinese, are installed includes three inter-task shared transformation units A(1), A(2), and A(3) corresponding to Japanese, English, and Chinese, respectively. The number of inter-language shared transformation units B(m) is equal to the number of tasks which can be handled by text label estimators installed in the identification apparatus. For example, the identification apparatus in which text label estimators that handle two tasks, topic identification and utterance act identification, are installed includes two inter-language shared transformation units B(1) and B(2).

<<Inter-Task Shared Transformation Unit A(n)>>
Input: a text (a word sequence) in a language n
Output: a latent vector (a universal latent vector)

Irrespective of the task m on which text label identification is to be performed, an inter-task shared transformation unit A(n) (where n=1, . . . , N) transforms, to a latent vector h, an input text in a certain language n

wⁿ=w₁ⁿ, . . . , w_{T}ⁿ,

where

wₜⁿ

represents one word, t=1, . . . , T holds, and T is the number of words contained in the input text wⁿ. That is, the inter-task shared transformation unit A(n) is configured for each language n. In the inter-task shared transformation unit A(n), the following transformation is performed.

h=INPUTtoHIDDEN (wⁿ; θ_{IN}ⁿ) (1)

The latent vector h is a universal latent vector and does not depend on the language n of the input text wⁿ. Here,

θ_{IN}ⁿ

is a parameter (a model parameter) which is used when text label identification handling the input text wⁿ in the language n is performed, and is used irrespective of the task m to be processed (that is, this parameter is jointly used in text label identification of all the tasks m=1, . . . , M for input texts in a certain language n). In the following description, due to notational constraints, this parameter is sometimes written as “θⁿ_{IN}”. The parameter θⁿ_{IN} defines the processing of a function INPUTtoHIDDEN( ) that transforms the input text wⁿ to the latent vector h. The inter-task shared transformation unit A(n) applies the function INPUTtoHIDDEN( )(an inter-task shared transformation function α(n) defined by the parameter θⁿ_{IN}), whose processing is defined by the parameter θⁿ_{IN}, to the input text wⁿ, and obtains the latent vector h corresponding to the input text wⁿ and outputs the latent vector h (Formula (1)). As INPUTtoHIDDEN( ) any function having this feature can be used; for example, a function for achieving the feature of RNN of Non-patent Literature 1 or CNN of Non-patent Literature 2 can be used. For learning of the parameter θ_{IN}, training data containing tuples of texts for the M types of tasks m=1, . . . , M in the language n and correct labels of the texts is used. That is, the parameter θⁿ_{IN} is learned using training data corresponding to all the tasks m=1, . . . , M in the language n. In other words, the parameter θⁿ_{IN} is learned such that text label identification of all the tasks m=1, . . . , M for input texts in the language n is possible. For example, the parameter θⁿ_{IN} that minimizes errors in text label identification of all the tasks m =1, M for texts in the language n contained in the training data is learned. For instance, the parameter θⁿ_{IN} that allows both the task of topic identification for an input text in Japanese and the task of utterance act identification for an input text in Japanese to be appropriately performed is learned. For example, learning is performed such that errors in both the task of topic identification and the task of utterance act identification are minimized.

<<Inter-Language Shared Transformation Unit B(m)>>
Input: the latent vector (the universal latent vector)
Output: an output label for a task m An inter-language shared transformation unit B(m) (where m=1, . . . , M) obtains, using the latent vector h as input, for all the tasks m=1, . . . , M, an output label

\hat{L}^{m}

corresponding to the latent vector h and outputs the output label. In the following description, due to notational constraints, this output label is sometimes written as “L\hat{ }^{m}”. As described earlier, the latent vector h does not depend on the language n of the input text. The inter-language shared transformation unit B(m) estimates the output label L\hat{ }^{m} in accordance with the following formula.

\hat{L}^{m}=HIDDENtoOUTPUT (h; θ_{OUT}^{m}) (2)

Here,

θ_{OUT}^{m}

is a parameter (a model parameter) which is used when text label identification of a task in is performed, and is used irrespective of the language n of the input text wⁿ (that is, this parameter is jointly used in text label identification of a certain task in for input texts in all the languages n=1, . . . , N). In the following description, due to notational constraints, this parameter is sometimes written as “θ^{m}_{OUT}”.

\hat{L}^{m}

is an output label obtained by text label identification of a task in. In the following description, due to notational constraints, the output label is sometimes written as “L\hat{ }^{m}”. The parameter θ^{m}_{OUT} defines the processing of a function HIDDENtoOUTPUT( ) that transforms the latent vector h to the output label L\hat{ }^{m}. The inter-language shared transformation unit B(m) applies the latent vector h to the function HIDDENtoOUTPUT( )(an inter-language shared transformation function θ(n) defined by the parameter θ^{m}_{OUT}) whose processing is defined by the parameter θ^{m}_{OUT}, and obtains an output label L\hat{ }^{m} corresponding to the latent vector h and outputs the output label L\hat{ }^{m} (Formula (2)). As HIDDENtoOUTPUT( ), any function having this feature can be used; for example, a function for achieving the feature of RNN of Non-patent Literature 1 or CNN of Non-patent Literature 2 can be used. For learning of the parameter θ^{m}_{OUT}, training data containing tuples of texts for a task m in all the languages n=1, . . . , N and correct labels of the texts is used. That is, the parameter θ^{m}_{OUT} is learned using training data corresponding to a task m in all the languages n=1, . . . , N. In other words, the parameter θ^{m}_{OUT} is learned such that text label identification of a task m for input texts in all the languages n=1, . . . , N is possible. For example, the parameter θ^{m}_{OUT} that minimizes errors in text label identification of a task m for texts in all the languages n=1, . . . , N contained in the training data is learned. For instance, the parameter θ^{m}_{OUT} that allows both the task of topic identification for an input text in Japanese and the task of topic identification for an input text in English to be appropriately performed is learned. For example, learning is performed such that errors in topic identification are minimized for both an input text in Japanese and an input text in English.

<Learning Apparatus>

The learning apparatus of the present embodiment obtains (estimates), using training data D containing tuples of texts for the M types of tasks m=1, . . . , M in the N types of languages n=1, . . . , N and correct labels of the texts as input, an optimized parameter group that defines the N inter-task shared transformation functions α(1), . . . , (N) corresponding to the N types of languages n=1, . . . , N and the M inter-language shared transformation functions α(1), . . . , α(M) corresponding to the M types of tasks m=1, . . . , M by learning processing (machine learning) and outputs the optimized parameter group. Each inter-task shared transformation function a(n) uses an input text in a certain language n as input and outputs a latent vector, which corresponds to the contents of the input text but does not depend on the language n, to the M inter-language shared transformation functions β(1), . . . , β(M). Moreover, each inter-language shared transformation function β(m) uses, as input, the latent vector output from any one of the N inter-task shared transformation functions α(1), . . . , α(N) and outputs an output label corresponding to the latent vector for a certain task m.
Input: a data group (training data D) containing tuples of texts for the N types of languages and the M types of tasks and correct labels of the texts
Output: an optimized parameter (an optimized parameter group)

The training data D is a set {D(1, 1), . . . , D(N, M)} of training data D(n, m) (where n=1, . . . , N and in=1, . . . , M). Here, the training data D(n, in) is training data of a task in in a language n. That is, the training data D(n, m) is a data group containing tuples of texts in the language n and correct labels of text label identification of the task in for the texts in the language n. In other words, a set of training data D(n, in) about all the combinations of the N types of languages n=1, . . . , N and the M types of tasks m=1, . . . , M can be used as the training data D. For example, when 1000 tuples of texts and correct labels thereof are prepared for one task in one language, the training data D made up of 1000×2×3=6000 tuples can be used for learning of an optimized parameter group corresponding to any combination of two languages and three tasks. It is to be noted that the number of tuples of texts and correct labels thereof in training data D(n, in) does not necessarily have to be equal to the number of tuples of texts and correct labels thereof in another training data D(n,

The learning apparatus of the present embodiment obtains, as an optimized parameter group θ\hat{ }, a parameter group θ that maximizes the probability that, when a text contained in the training data D is input as an input text to text label discriminators including the N inter-task shared transformation functions α(1), . . . , α(N) and the M inter-language shared transformation functions β(1), . . . , β(M) which are defined by the parameter group θ, a correct label of the text input as the input text is output, and outputs the optimized parameter group θ\hat{ }. A superscript “\hat{ }” of “θ\hat{ }” is supposed to be placed directly above “θ”, but, due to notational constraints, it is placed to the upper right of θ. For example, the learning apparatus obtains, as an optimized parameter group,

$$\hat{θ} = {argmax}_{θ} {\sum }_{D ( n , m ) ∈ D} \frac{1}{\vert D ( n , m ) \vert} {\sum }_{w ∈ D ( n , m )} {\sum }_{L} \hat{P} ( L \vert w ) log P ( L \vert w , θ )$$

and outputs the optimized parameter group θ\hat{ }. Here, argmax_{θ}γ represents a parameter group θ that maximizes y, D represents training data D={D(1, 1), . . . , D(N, M)}, D(n, in) represents training data of a task in in a language n which is contained in the training data D, and |D(n, in)| represents the number of texts contained in D(n, m). w represents a text contained in the training data, L represents a correct label contained in the training data, and P\hat{ }(L|w) represents the probability that an output label is a correct label; P\hat{ }(L|w)=1 holds if L is a correct label of w and P\hat{ }(L|w)=0 holds if L is not a correct label of w. It is to be noted that P\hat{ }(L|w) represents

\hat{P}(L|w)

P(L|w, θ) represents the value of the predicted probability that L is output as an output label when w is input as an input text to text label discriminators including the N inter-task shared transformation functions α(1), . . . , α(N) and the M inter-language shared transformation functions β(1), . . . , β(M) which are defined by the parameter group θ. logX represents the logarithm of X. log to any base can be used. Examples of the base of log are “Napier's constant”, “10”, “2”, and the like. The parameter group θ includes a parameter

θ_{IN}ⁿ

that defines an inter-task shared transformation function α(n) (where n=1, . . . , N) and a parameter

θ_{OUT}^{m}

that defines an inter-language shared transformation function β(m) (where m=1, . . . , M). When a parameter that defines an inter-task shared transformation function α(n) is written as “θⁿ_{IN}” and a parameter that defines an inter-language shared transformation function β(m) is written as “θ^{m}_{OUT}” due to notational constraints, θ={θ¹_{IN}, . . . , θ^{N0}_{IN}, θ¹_{OUT}, . . . , θ^{M}_{OUT}} holds. Various techniques can be used to solve this optimization; for example, error backpropagation or the like can be used. Error backpropagation is a publicly known technique and explanations thereof are omitted.

### Embodiment

Next, the embodiment will be described using the drawings.

21 Configuration>

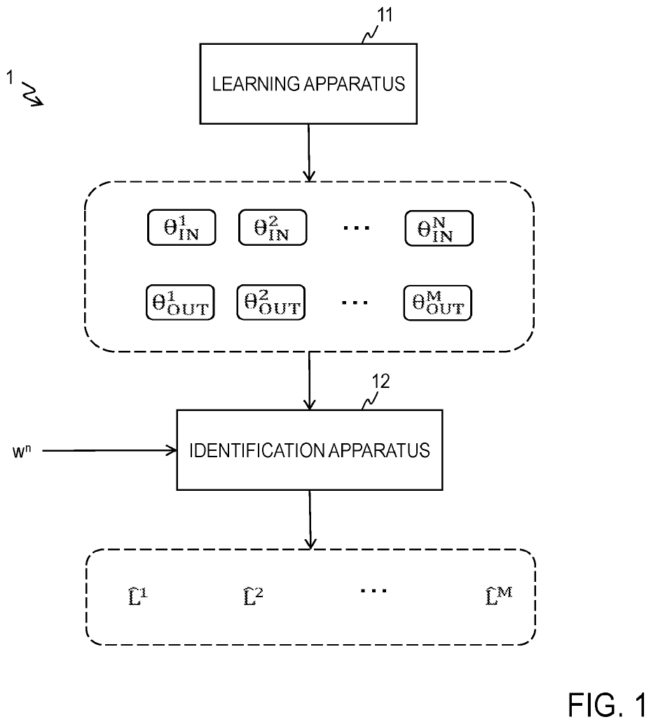

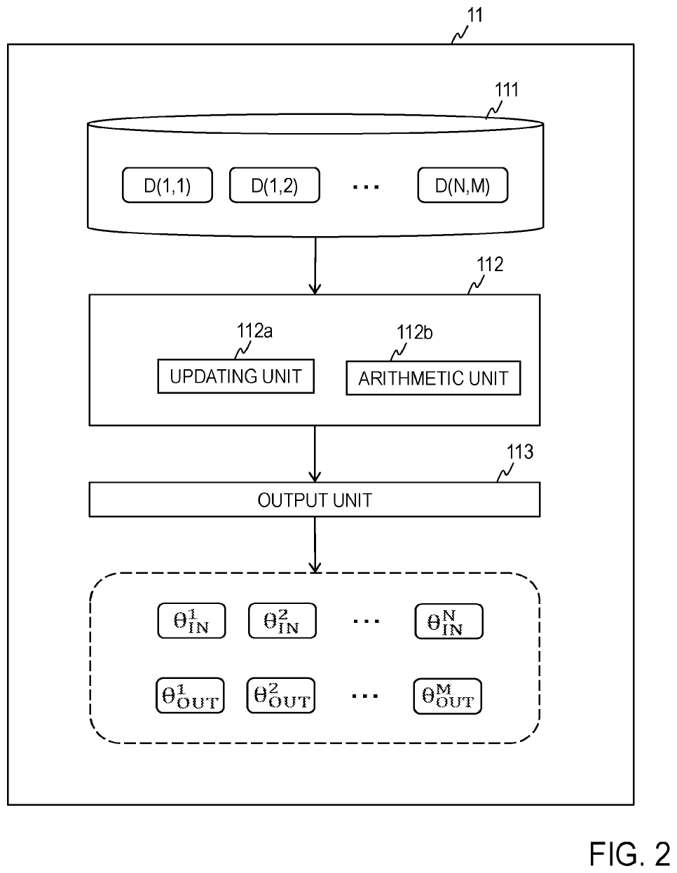

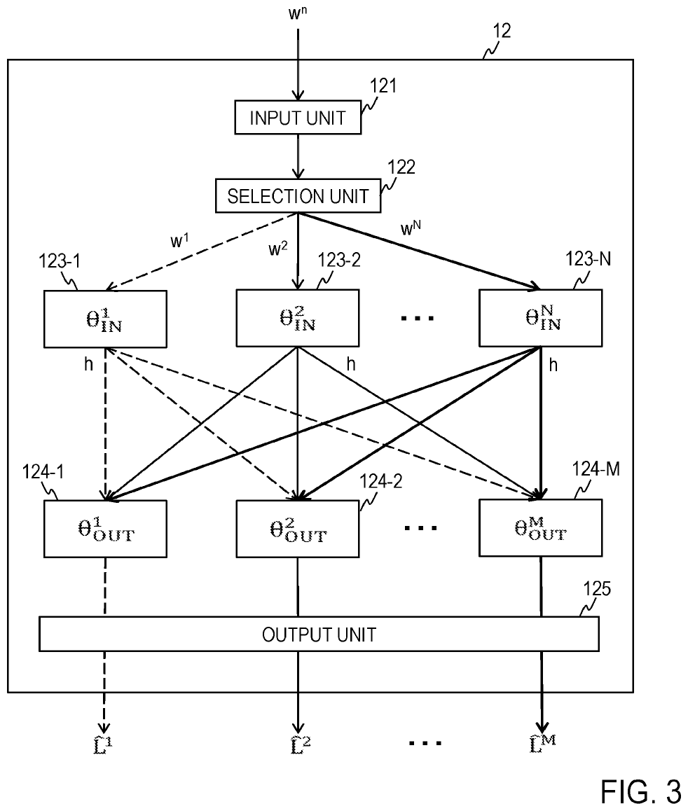

As illustrated in FIG. 1, an identification system 1 of the present embodiment includes a learning apparatus 11 and an identification apparatus 12. As illustrated in FIG. 2, the learning apparatus 11 of the present embodiment includes a storage 111, a learning unit 112, and an output unit 113. The learning unit 112 includes an updating unit 112a and an arithmetic unit 112b. As illustrated in FIG. 3, the identification apparatus 12 includes an input unit 121, a selection unit 122, an inter-task shared transformation unit 123-n (“A(n)”), an inter-language shared transformation unit 124-m (“B(m)”), and an output unit 125.

<Learning Processing>

Learning processing which is performed by the learning apparatus 11 will be described. Prior to learning processing, training data D={D(1, 1), . . . , D(N, M)} (training data containing tuples D(n, in) of texts for the M types of tasks m=1, . . . , M in the N types of languages n=1, . . . , N and correct labels of the texts) is stored in the storage 111 of the learning apparatus 11. The learning unit 112 reads the training data D from the storage 111, and obtains an optimized parameter group θ={θ¹_{IN}, . . . , θ^{N}_{IN}, θ¹_{OUT}, . . . , θ^{M}_{OUT}} that defines the N inter-task shared transformation functions a(1), a(N) corresponding to the N types of languages n=1, . . . , N and the M inter-language shared transformation functions β(1), . . . , β(M) corresponding to the M types of tasks m=1, . . . , M by learning processing (machine learning) and outputs the optimized parameter group θ. In this learning processing, arithmetic processing in which the arithmetic unit 112b performs an arithmetic operation (for example, a calculation of a loss function) to update the parameter group and updating processing in which the updating unit 112a updates the parameter group based on the arithmetic operation result (for example, the function value of the loss function) obtained by the arithmetic unit 112b are repeated. Various publicly known techniques can be used for this learning processing; for example, error backpropagation or the like can be used. The output unit 113 outputs the optimized parameter group θ output from the learning unit 112. The optimized parameter group θ is input to the identification apparatus 12, whereby the N inter-task shared transformation functions α(1), . . . , α(N) corresponding to the N types of languages n=1, . . . , N and the M inter-language shared transformation functions β(1), . . . , β(M) corresponding to the M types of tasks m=1, . . . , M are defined. That is, an inter-task shared transformation function a(n) which is used in the inter-task shared transformation unit 123-n is defined by the parameter θⁿ_{IN} (Formula (1)) and an inter-language shared transformation function β(m) which is used in the inter-language shared transformation unit 124-m is defined by the parameter θ_{OUT} (Formula (2)).

<Identification Processing>

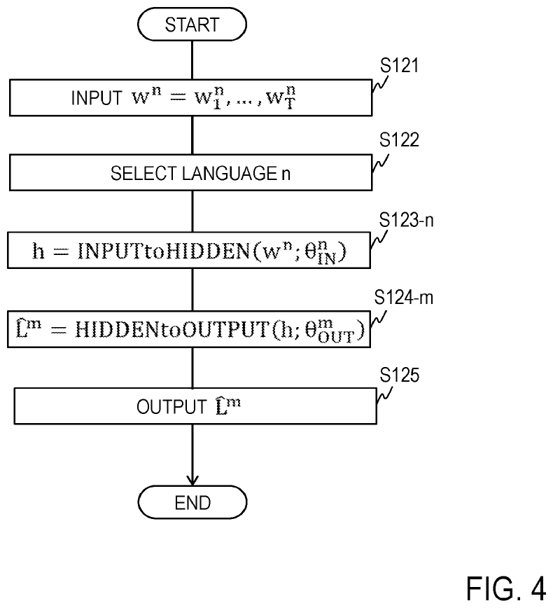

Identification processing which is performed by the identification apparatus 12 will be described using FIG. 4.

First, an input text wⁿ in a certain language n ∈ {1, . . . , N} is input to the input unit 121. The input text wⁿ may be a text contained in the training data D or a text that is not contained in the training data D (Step S121). The input text wⁿ is transmitted to the selection unit 122, and the selection unit 122 transmits the input text wⁿ to the inter-task shared transformation unit 123-n corresponding to the language n (Step S122). The inter-task shared transformation unit 123-n applies the inter-task shared transformation function α(n) to the input text wⁿ, obtains a latent vector h which corresponds to the contents of the input text wⁿ but does not depend on the language n (obtains h by performing an arithmetic operation of Formula (1)), and outputs the latent vector h to M inter-language shared transformation units 124-1, . . . , 124-M (Step S123-n). The latent vector h is input to the M inter-language shared transformation units 124-1, . . . , 124-M. Each inter-language shared transformation unit 124-m (where in E {1, . . . , M}) applies the inter-language shared transformation function β(m) to the latent vector h output from the inter-task shared transformation unit 123-n (any one of N inter-task shared transformation units 123-1, . . . , 123-N), obtains an output label L\hat{ }^{m} corresponding to the latent vector h for a task in (obtains an output label L\hat{ }^{m} by performing an arithmetic operation of Formula (2)), and outputs the output label L\hat{ }^{m} (Step S124-m). As a result, M output labels L\hat{ }¹, . . . , L\hat{ }^{M} are output from the identification apparatus 12 (Step S125).

[Modifications and So forth]

It is to be noted that the present invention is not limited to the above-described embodiment. For example, in the above-described embodiment, the learning apparatus 11 and the identification apparatus 12 are different apparatuses; these apparatuses may be integrated into a single apparatus. Moreover, in the above-described embodiment, machine learning is performed using the training data stored in the storage 111 of the learning apparatus 11; the learning apparatus 11 may perform machine learning using the training data stored in a storage outside the learning apparatus 11. Alternatively, the training data in the storage 111 of the learning apparatus 11 may be updated and the learning apparatus 11 may perform machine learning using the updated training data. Furthermore, the M output labels L\hat{ }¹, . . . , L\hat{ }^{M} are output from the identification apparatus 12 in Step S125; only an output label, which corresponds to a selected task m, of the output labels L\hat{ }¹, . . . , L\hat{ }^{M} may be output. When only an output label, which corresponds to a selected task in, of the output labels L\hat{ }¹, . . . , L\hat{ }^{M} is output, processing which is performed by the inter-language shared transformation unit 124-m corresponding to an unselected task may be omitted.

The above-described various kinds of processing may be executed, in addition to being executed in chronological order in accordance with the descriptions, in parallel or individually depending on the processing power of an apparatus that executes the processing or when necessary. In addition, it goes without saying that changes may be made as appropriate without departing from the spirit of the present invention.

The above-described each apparatus is embodied by execution of a predetermined program by a general- or special-purpose computer having a processor (hardware processor) such as a central processing unit (CPU), memories such as random-access memory (RAM) and read-only memory (ROM), and the like, for example. The computer may have one processor and one memory or have multiple processors and memories. The program may be installed on the computer or pre-recorded on the ROM and the like. Also, some or all of the processing units may be embodied using an electronic circuit that implements processing functions without using programs, rather than an electronic circuit (circuitry) that implements the functional configuration by loading of programs like a CPU. An electronic circuit constituting a single apparatus may include multiple CPUs.

When the above-described configurations are implemented by a computer, the processing details of the functions supposed to be provided in each apparatus are described by a program. As a result of this program being executed by the computer, the above-described processing functions are implemented on the computer. The program describing the processing details can be recorded on a computer-readable recording medium. An example of the computer-readable recording medium is a non-transitory recording medium. Examples of such a recording medium include a magnetic recording apparatus, an optical disk, a magneto-optical recording medium, and semiconductor memory.

The distribution of this program is performed by, for example, selling, transferring, or lending a portable recording medium such as a DVD or a CD-ROM on which the program is recorded. Furthermore, a configuration may be adopted in which this program is distributed by storing the program in a storage apparatus of a server computer and transferring the program to other computers from the server computer via a network.

The computer that executes such a program first, for example, temporarily stores the program recorded on the portable recording medium or the program transferred from the server computer in a storage apparatus thereof. At the time of execution of processing, the computer reads the program stored in the storage apparatus thereof and executes the processing in accordance with the read program. As another mode of execution of this program, the computer may read the program directly from the portable recording medium and execute the processing in accordance with the program and, furthermore, every time the program is transferred to the computer from the server computer, the computer may sequentially execute the processing in accordance with the received program. A configuration may be adopted in which the transfer of a program to the computer from the server computer is not performed and the above-described processing is executed by so-called application service provider (ASP)-type service by which the processing functions are implemented only by an instruction for execution thereof and result acquisition.

Instead of executing a predetermined program on the computer to implement the processing functions of the present apparatuses, at least some of the processing functions may be implemented by hardware.

### INDUSTRIAL APPLICABILITY

The present invention can be used in, for example, interactive systems and the like.

### DESCRIPTION OF REFERENCE NUMERALS

1 identification system

11 learning apparatus

112 learning unit

12 identification apparatus

123-n inter-task shared transformation unit

124-m inter-language shared transformation unit

1. A learning apparatus comprising:
a learning unit that obtains, using training data containing tuples of texts for M types of tasks m=1, . . . , M in N types of languages n=1, . . . , N correct labels of the texts as input, an optimized parameter group that defines N inter-task shared transformation functions α(1), . . . , α(N) corresponding to the N types of languages n=1, N and M inter-language shared transformation functions β(1), . . . , β(M) corresponding to the M types of tasks m=1, . . . , M by learning processing and outputs the optimized parameter group, wherein
at least one of N and M is an integer greater than or equal to 2,
each of the inter-task shared transformation functions α(n) uses an input text in a certain language n as input and outputs a latent vector, which corresponds to contents of the input text but does not depend on the language n, to the M inter-language shared transformation functions β(1), . . . , β(M), and
each of the inter-language shared transformation functions β(m) uses, as input, the latent vector output from any one of the N inter-task shared transformation functions α(1), . . . , α(N) and outputs an output label corresponding to the latent vector for a certain task m.

2. The learning apparatus according to claim 1, wherein the learning unit obtains, as the optimized parameter group, a parameter group that maximizes a probability that, when a text contained in the training data is input as the input text to text label discriminators including the N inter-task shared transformation functions α(1), . . . , α(N) and the M inter-language shared transformation functions β(1), . . . , β(M) which are defined by the parameter group, a correct label of the text input as the input text is output, and outputs the optimized parameter group.

3. The learning apparatus according to claim 1 or 2, wherein
the learning unit obtains, as the optimized parameter group,
$$\hat{θ} = {argmax}_{θ} {\sum }_{D ( n , m ) ∈ D} \frac{1}{\vert D ( n , m ) \vert} {\sum }_{w ∈ D ( n , m )} {\sum }_{L} \hat{P} ( L \vert w ) log P ( L \vert w , θ )$$
and outputs the optimized parameter group, and
argmax_{θ}γ represents a parameter group θ that maximizes γ, D={(D(1, 1), . . . , D(N, M)} represents the training data, D(n, m) represents training data of a task m in a language n, |D(n, m)| represents the number of texts contained in D(n, m), w represents a text, L represents a correct label, P\hat{ }(L|w)=1 holds if L is a correct label of w and P\hat{ }(L|w)=0 holds if L is not a correct label of w, P\hat{ }(L|w) is
\hat{P}(L|w),
and P(L|w, θ) represents a value of a predicted probability that L is output as the output label when w is input as the input text to text label discriminators including the N inter-task shared transformation functions α(1), α(N) and the M inter-language shared transformation functions β(1), . . . , β(M) which are defined by the parameter group θ.

4. An identification apparatus comprising:
N inter-task shared transformation units A(n) corresponding to N types of languages n=1, . . . , N; and
M inter-language shared transformation units B(m) corresponding to M types of tasks m=1, . . . , M, wherein
at least one of N and M is an integer greater than or equal to 2,
N inter-task shared transformation functions α(1), . . . , α(N) corresponding to the N types of languages n=1, . . . , N and M inter-language shared transformation functions β(1), . . . , β(M) corresponding to the M types of tasks m=1, . . . , M are defined,
each of the inter-task shared transformation units A(n) applies an inter-task shared transformation function α(n) to an input text in a certain language n and outputs a latent vector, which corresponds to contents of the input text but does not depend on the language n, to M inter-language shared transformation units β(1), . . . , B(M), and
each of the inter-language shared transformation units B(m) applies an inter-language shared transformation function β(m) to the latent vector output from any one of N inter-task shared transformation units A(1), . . . , A(N) and outputs an output label corresponding to the latent vector for a certain task m.

5. A learning method of a learning apparatus, the learning method comprising:
a learning step of obtaining, using training data containing tuples of texts for M types of tasks m=1, . . . , M in N types of languages n=1, . . . , N and correct labels of the texts as input, an optimized parameter group that defines N inter-task shared transformation functions α(1), . . . , α(N) corresponding to the N types of languages n=1, . . . , N and M inter-language shared transformation functions β(1), . . . , β(M) corresponding to the M types of tasks m=1, . . . , M by learning processing and outputting the optimized parameter group, wherein
at least one of N and M is an integer greater than or equal to 2,
each of the inter-task shared transformation functions a(n) uses an input text in a certain language n as input and outputs a latent vector, which corresponds to contents of the input text but does not depend on the language n, to the M inter-language shared transformation functions β(1), . . . , β(M), and
each of the inter-language shared transformation functions β(m) uses, as input, the latent vector output from any one of the N inter-task shared transformation functions α(1), . . . , α(N) and outputs an output label corresponding to the latent vector for a certain task m.

6. The learning method according to claim 5, wherein
the learning step obtains, as the optimized parameter group,
$$\hat{θ} = {argmax}_{θ} {\sum }_{D ( n , m ) ∈ D} \frac{1}{\vert D ( n , m ) \vert} {\sum }_{w ∈ D ( n , m )} {\sum }_{L} \hat{P} ( L \vert w ) log P ( L \vert w , θ )$$
and outputs the optimized parameter group, and
argmax_{θ}γ represents a parameter group θ that maximizes γ, D={D(1, 1), . . . , D(N, M)} represents the training data, D(n, m) represents training data of a task m in a language n, |D(n, m)| represents the number of texts contained in D(n, m), w represents a text, L represents a correct label, P\hat{ }L|w)=1 holds if L is a correct label of w and P\hat{ }(L|w)=0 holds if L is not a correct label of w, P\hat{ }(L|w) is
\hat{P}(L|W),
and P(L|w, θ) represents a value of a predicted probability that L is output as the output label when w is input as the input text to a text label discriminator including the inter-task shared transformation function α(n) and the inter-language shared transformation function 13(m) which are defined by the parameter group θ.

7. An identification method of an identification apparatus, wherein
at least one of N and M is an integer greater than or equal to 2 and N inter-task shared transformation functions α(1), . . . , α(N) corresponding to N types of languages n=1, . . . , N and M inter-language shared transformation functions β(1), . . . , β(M) corresponding to M types of tasks m=1, . . . , M are defined, and the identification method comprises:
an inter-task shared transformation step in which an inter-task shared transformation unit A(n) applies an inter-task shared transformation function α(n) to an input text in a certain language n and outputs a latent vector, which corresponds to contents of the input text but does not depend on the language n, to M inter-language shared transformation units B(1), . . . , B(M); and
an inter-language shared transformation step in which an inter-language shared transformation unit B(m) applies an inter-language shared transformation function β(m) to the latent vector output from any one of N inter-task shared transformation units A(1), . . . , A(N) and outputs an output label corresponding to the latent vector for a certain task m.

8. A program for making a computer function as the learning apparatus according to claim 1 or 2.

9. A program for making a computer function as the identification apparatus according to claim 4.
